(19) United States
(12) Patent Application Publication
(10) Pub. No.: US 2026/0073899 A1
(43) Pub. Date: Mar. 12, 2026

(54) Enhanced Music Delivery Service With Metadata

(71) Applicant: DTS Inc., Calabasas, CA (US)

(72) Inventors: Martin Walsh, Scotts Valley, CA (US); Aaron Warner, Seattle, WA (US); Brandon Smith, Kirkland, WA (US)

(21) Appl. No.: 18/869,938

(22) PCT Filed: May 25, 2023
(86) PCT No.: PCT/US2023/067489

§ 371 Date: Nov. 27, 2024

Related U.S. Application Data
(60) Provisional application No. 63/347,503, filed on May 31, 2022.

(51) Int. Cl. G10H 1/02; G10H 1/36

(52) U.S. Cl. CPC G10H 1/02; G10H 1/366; G10H 2210/031; G10H 2210/155; G10H 2240/075

(57) ABSTRACT

Generally disclosed herein is an approach for enhancing the music delivery system and service by extracting application-specific stems from standard pre-mixed music content. The approach also includes analyzing the pre-mixed music content and generating metadata based on the analyzed pre-mixed music content. The approach further includes distributing the metadata with the original music content to a user device. The approach also includes post-processing the original music content using the metadata for various applications.

### CROSS REFERENCE TO RELATED APPLICATIONS

The present application claims the benefit of the filing date of U.S. Provisional Application No. 63/347,503 filed May 31, 2022, entitled Enhanced Music Delivery System And Service With Metadata, the disclosure of which is hereby incorporated herein by reference.

### BACKGROUND

Karaoke and music track remixing may use stems of original music content. Stems, sometimes referred to as music stems or song stems, arc a type of audio file that breaks down a complete music track into individual mixes. For example, stems may break into different tracks for melody, instruments, bass, and drums. A drum stem, for example, will typically be a stereo audio file that contains a mix of all percussive sounds. When song stems are played simultaneously, the track should sound like the mastered version.

There are several applications that can make use of subsets of such stems if they are provided by the original copyright holder. These include karaoke (removal of lead vocals) and music track remixing. However, these applications generally require that such subsets are distributed as multiple tracks that are supplemental to the originally mixed content. Music distribution where the content is in a pre-mixed stereo format precludes the distribution of stem-based content in a ubiquitous manner.

### BRIEF SUMMARY

This present disclosure provides for the extraction of application-specific stems from standard pre-mixed content by analyzing that pre-mixed content, generating application-specific and stem-specific metadata, and distributing that metadata with the original content. The metadata may be used to augment otherwise blind audio source separation algorithms and/or optimize post-processing to yield a desired end-user experience. If a receiving system is not compatible with the post-processing architecture described herein, the audio will still play with the metadata extensions ignored. In some examples, the metadata may contain digital rights management relating to what post-processing can be applied to a piece of content and by whom.

According to some aspects of the disclosure, audio processing effects that were applied to a particular stem of the original music content are detected. If the original stem is to be replaced with a user's voice input, such as in a karaoke application when the user's voice will be played with the original instrumentals, drums, etc., the user's voice input can be processed in real time using the same audio processing effects that were applied to the original version, In this regard, when integrating the processed user audio input with the original music content, the track sounds similar to the original music content.

An aspect of the disclosure provides a method for enhancing music delivery service with metadata. The system includes one or more processors and memory in communication with the one or more processors, wherein the memory contains instructions configured to cause the one or more processors to receive original music content. The instructions are also configured to cause the one or more processors to detect effects applied to the original music content. The instructions are further configured to cause the one or more processors to receive user audio input. The instructions are further configured to cause the one or more processors to modify, in real time, the user audio input by applying effects based on the detected effects applied to the original music content. The instructions are further configured to cause the one or more processors to integrate the modified user audio input with the original music content.

In another example, the user audio input comprises a vocal sound of the user.

In yet another example, the user audio input comprises an instrumental sound made from an instrument played by the user.

In yet another example, detecting the effects applied to the original music content comprises accessing metadata associated with the original music content.

In yet another example, the metadata includes a song key, song lyrics, timing relating to a musical structure, and an artist's vocal features.

In yet another example, the metadata includes information related to digital rights of the original music content, wherein the digital rights of the original music content include information relating to what post-processing can be applied to a piece of the original music content and by whom.

In yet another example, the effect comprises autotune, reverb, and chorus.

In yet another example, the instructions are further configured to cause the one or more processors to generate metadata based on the detected effects and to store the generated metadata with the original music content.

In yet another example, the instructions are further configured to cause the one or more processors to separate subsets of sound mixes contained in the original music content.

In yet another example, the instructions are further configured to cause the one or more processors to separate the subsets of the sound mixes using a machine-learning model.

In yet another example, the instructions are further configured to cause the one or more processors to integrate the user audio input with a vocal sound of the original music contents by replacing the vocal sounds of the original music contents with the user audio input when the user audio input is received for a musical frame and by playing the vocal sound of the original music contents when the user audio input is not received for the musical frame.

Another aspect of the disclosure provides a method for enhancing music delivery service with metadata. The method includes receiving, by one or more processors, original music content. The method further includes detecting, by the one or more processors, effects applied to the original music content. The method also includes receiving, by the one or more processors, user audio input. The method further includes modifying, by the one or more processors, in real time, the user audio input by applying effects based on the detected effects applied to the original music content. The method also includes integrating, by the one or more processors, the modified user audio input with the original music content.

In another example, the user audio input comprises a vocal sound of the user.

In yet another example, the user audio input comprises an instrumental sound made from an instrument played by the user.

In yet another example, detecting the effects applied to the original music content comprises accessing metadata associated with the original music content.

In yet another example, the metadata includes information related to digital rights of the original music content.

In yet another example, the effect comprises autotune, reverb, and chorus.

In yet another example, the method further includes generating metadata based on the detected effects and storing the generated metadata with the original music content.

Another aspect of the disclosure provides a non-transitory machine-readable medium comprising machine-readable instructions encoded thereon for performing a method of enhancing music delivery service with metadata. The method also includes receiving original music content. The method further includes detecting effects applied to the original music content. The method also includes receiving user audio input. The method further includes modifying, in real time, the user audio input by applying effects based on the detected effects applied to the original music content. The method also includes integrating the modified user audio input with the original music content.

### BRIEF DESCRIPTION OF THE DRAWINGS

FIG. 1A illustrates an example enhanced music delivery service system according to aspects of the disclosure.

FIG. 1B illustrates an example enhanced music delivery system deployed in a karaoke application according to aspects of the disclosure.

FIG. 1C illustrates an example enhanced music delivery system for removing music stems for instrumental accompaniment and learning according to aspects of the disclosure.

FIG. 1D illustrates an example enhanced music delivery system for performing stem-based post-processing according to aspects of the disclosure.

FIG. 2A depicts a block diagram of an example karaoke application according to aspects of the disclosure.

FIG. 2B depicts a block diagram of an example duet karaoke application according to aspects of the disclosure.

FIG. 3 depicts a block diagram illustrating the computing components of an example music delivery service system according to aspects of the disclosure.

FIG. 4 depicts a flow diagram of an example method for enhanced music delivery service according to aspects of the disclosure.

### DETAILED DESCRIPTION

The present disclosure provides for enhancing the music delivery system and service by extracting application-specific stems from standard pre-mixed music content. Moreover, it provides for analyzing the pre-mixed music content and generating metadata based on the analyzed pre-mixed music content. It further includes distributing the metadata with the original music content to a user device. The approach also includes post-processing the original music content using the metadata for various applications.

In some examples, the original music content may be analyzed for application-specific features. For example, if the original music content is used by a user for karaoke purposes, the application-specific features may include tones of the lead vocal, loudness of the backing instrumental sounds, special effects applied to the sound of the lead vocal, etc. Such features may be extracted and stored in a database as metadata of the original music content. The extraction of features and generation of metadata may be performed offline by a system or service. In some examples, the metadata may be generated using a machine-learning model in real time. The machine learning model may generate unique metadata for each application-specific feature.

According to some examples, the generated metadata may be sent from the system or service to the user with the original music content. In some examples, even if legacy systems may not be capable of receiving the metadata, the original music content can be played while ignoring the metadata.

According to some examples, different metadata from the original metadata of the original music content may be generated if the original music content is perceptually compressed. Perceptually compressed music content may omit valid but unimportant sounds that a human listener may not hear or consider unimportant. In such a case, the metadata may not contain the same information as in the original music content that is not perceptually compressed. For example, if the original music content is perceptually compressed, certain instrumental sounds may be indistinguishable from another instrumental sound. The metadata may be generated on the combined instrumental sound, rather than individual metadata separately generated for the first instrumental and second instrumental sounds.

According to some examples, a user device may include one or more processors configured to perform a stem separation technique and/or post-processing technique. The user device may unmix the audio stems from the original music content using the stem separation technique. The stem separation technique may separate application-specific stems. For example, the stem separation technique may separate a stem from another stem according to different applications. If a user wants to use the original music content for karaoke, the stem separation technique may separate the vocal stem from the original mix. The post-processing technique may mute or attenuate the extracted vocal stem relative to the residual original mix when the user's audio input is detected on an auxiliary system input.

According to some examples, stem separation and post-processing techniques may make use of any metadata that is defined as relevant to their application-specific functioning. For example, if the original music content does not have any metadata related to vocal stems when transmitted to a user device, the stem separation technique embedded in the user device may utilize a machine-learning model to identify and separate the vocal stem.

According to some examples, the machine learning models may be utilized with varied weights and coefficients that may be modified according to the user's desired output stems. The user may change or adjust the weights and coefficients. If the user, for example, only desires to separate and modify vocal stems from the original music content, the user may increase the weights of the pre-trained machine learning model. Several pre-trained model weights may be changed based on the user's desired application. For example, a pre-trained machine learning model may use one set of weights to separate vocals from the original music content and another set of weights if the user wishes to separate the guitar stem or piano stem.

In some examples, the post-processing technique may make use of the metadata to display music lyrics, a text stream, and a video stream. In other examples, the aforementioned data may be in the form of a linked reference to the metadata and not the metadata itself. The post-processing technique may also receive and process the user's auxiliary audio and/or video inputs.

According to some examples, the original music content may be distributed with karaoke-specific metadata. The karaoke-specific metadata may include information related to the artist's vocal features, original song key, vocal effects, song lyrics, and timing relating to the musical structure of tracks such as the timing of the song chorus and when certain effects are applied to the music. In some examples, the metadata may also include information related to the original music content's digital rights. For example, the original music content's digital rights may contain the restrictions that the publisher or the owner of the original music content may not permit the distribution of a karaoke version of the music content, or such use is permitted on a subscription basis.

In some examples, the original music content may be analyzed at the user device for relevant metadata and the metadata may be utilized for the post-processing techniques. If relevant metadata is not present, the user device may assume that default information (e.g., default song key or default sound effects configured by the user) may be received for each stem such that the original music content may still be processed without receiving the metadata from the distributor. In other examples, certain metadata may be extracted from the original music content using alternative real-time processing if the metadata is not available. For example, the user device may detect a song key of the original music content without extracting the metadata.

According to some examples, the stem separation techniques for karaoke processing features may separate the original music content into stems for lead singers, backing singers, and music. The stem separation technique may also utilize relevant metadata such as artist or song-specific embeddings that may be used to condition the stem separation technique for more accurate results.

In some examples, a user device can operate in solo karaoke mode or duet mode. In solo karaoke mode, the original lead singer's vocals may be partially or fully attenuated for the duration of the song, and the user audio input may be mixed with the stems for backing singers and music. In duet karaoke mode, the original lead singer's vocals may be partially or fully attenuated only when the user's audio input is received at a microphone unit, such that the resulting track alternates between the original lead singer's vocals and the user's audio input. According to some examples, whether to attenuate the original lead singer's vocals depends not only on whether user audio input is being received but also on a part of the song for which the user audio input is being received. For example, when the user's audio input is detected during the song chorus, the lead singer's vocals of the original music content may be enabled such that both the user's and the original lead singer's voices are played together. The metadata may indicate whether the part of the song is a segment for which the lead singer's vocals should be attenuated if user audio input is received, or whether it is a segment for which both the lead singers'vocals and the user audio input should be played.

In some examples, the user audio input received at the microphone may be processed to apply the same voice effects that were applied to the original music content. Such effects may include, for example, reverb, chorus, autotuning, or other effects. The information related to the applied effects may be stored as metadata with the original music content and accessed by the user device such that it can dynamically match the user's singing voice to the original lead singer's voice. In some other examples, various effects may be detected by the user' device without metadata.

According to some examples, song lyrics can be synchronized with the user's audio input when karaoke mode is enabled. The synchronized song lyrics may be displayed via a graphical user interface. In some other examples, the song lyrics may be stored directly as metadata or indirectly stored using a unique identifier and/or a uniform resource locator (URL).

In some examples, the relative loudness level of the vocal sound of the original music content may be distributed as metadata. When a user's singing voice is input to the user device through a microphone, the user's loudness level may be matched to the loudness of the original vocal stem of the original music content using an automatic gain control (AGC) circuit or a loudness normalization algorithm.

According to some examples, the user audio input may be instrumental, such as if the user is playing a musical instrument into the microphone instead of or in addition to singing. A specific instrument or group of instruments may be separated from the original music content and attenuated or muted, thereby allowing a user to play the separated instrumental components along with the rest of the original music content. While the user plays the instrument, the most appropriate music notation may be displayed via a graphical user interface. In some examples, music notations that reflect different difficulty levels may be displayed based on the user's competency.

In some examples, the original music content may be distributed with music instrument-specific metadata. Such metadata may include digital embedding relating to a specific instrument that may condition the stem separation technique to isolate the sound of a particular instrument. The metadata may also include the original song key, parameters relating to audio effects applied to the original music content, and the original instruments during the production of the original music content such as reverb, chorus, and pedal effects. Music notations or a URL describing a location to find the music notations may be displayed to the user via a graphical user interface. Guitar tablature, drum notation, standard music notation, lead sheets, or other graphical music notation may also be displayed. The timing relating to the musical structure of the original music content such as tempo, song chorus, timing of sound effects, and digital rights relating to the original music content may be distributed with the original music content. In other examples, the metadata may contain sound modules that may be loaded into a synthesizer such that the user may play the original instrument sound on a keyboard.

In some examples, the stem separation technique may separate the original music content into stems for vocals, drums, bass, and guitar sounds in instrumental mode. The stem separation algorithm technique may make use of the relevant metadata such as instrument, artist, or song-specific embeddings that may allow the stem separation technique to use additional features. The separated stems may be passed to an audio mixer and effects processor. In one example, an original instrument may partially or fully be attenuated for the duration of the original music content. In some other examples, the user's accompanying performance may be mixed with the remaining music stems. The user's input audio from the user's instrumental performance may be input as a microphone signal, a midi signal, or a digital waveform.

In some examples, the user device may operate in a dueling instrumental mode, in which an original instrument may be partially or fully attenuated only when an accompanying instrument is detected as audio input. In this regard, the instrument sound played by the user and the remaining instrument sound of the original music content may sound like a duet. The user's instrumental playback may be passed from the microphone or other input device to an effects processor such that the effects applied to the instruments of the original music content may be applied to the user's instrumental playback.

According to some examples, in solo instrument mode, all stems except the instrument of interest may be partially or fully attenuated to facilitate listening to only the solo instrument part for learning purposes.

According to some examples, a stem processor may apply different DSP effects to different stems. For example, the stem processor may apply different music effect plugins to different instruments. If a user wants to enhance or emphasize the original music content's percussive beat during sports events, for example, the stem processor may change the loudness or dynamics of the drum sounds of the original music content. In other examples, the vocals may be processed with reverb effects to create a more ethereal version of a ballad song.

In some examples, the available stem-specific effect may be identified by the original music content's metadata. Such metadata may include a definition of how the stems can be segmented, what effects can be applied to each stem, the parameter ranges of each effect unit for each stem, digital embeddings related to a specific instrument or set of stems that may enhance the stem separation technique to isolate an instrument sound.

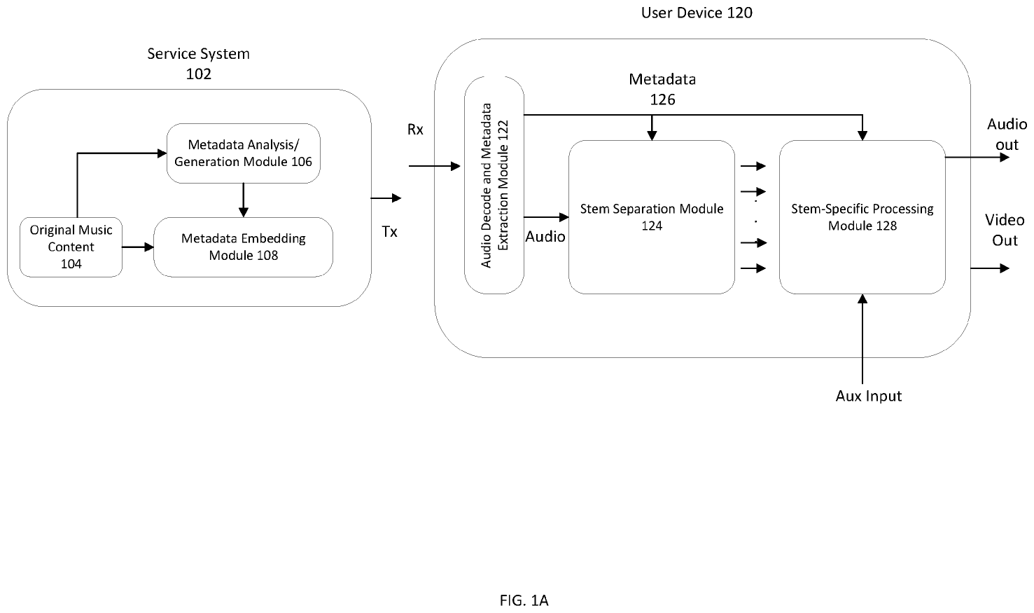

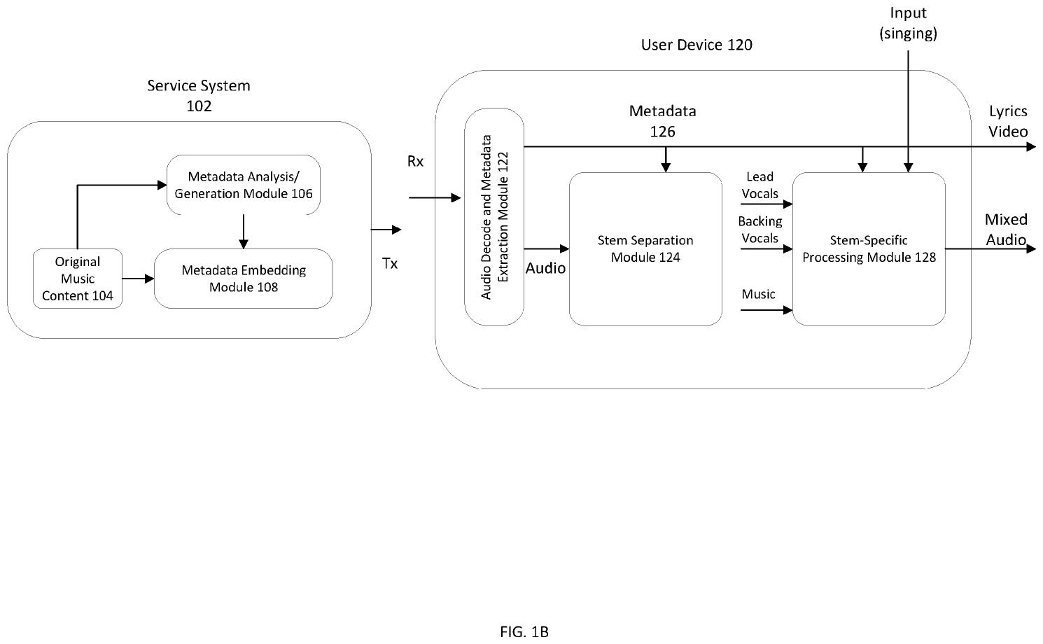

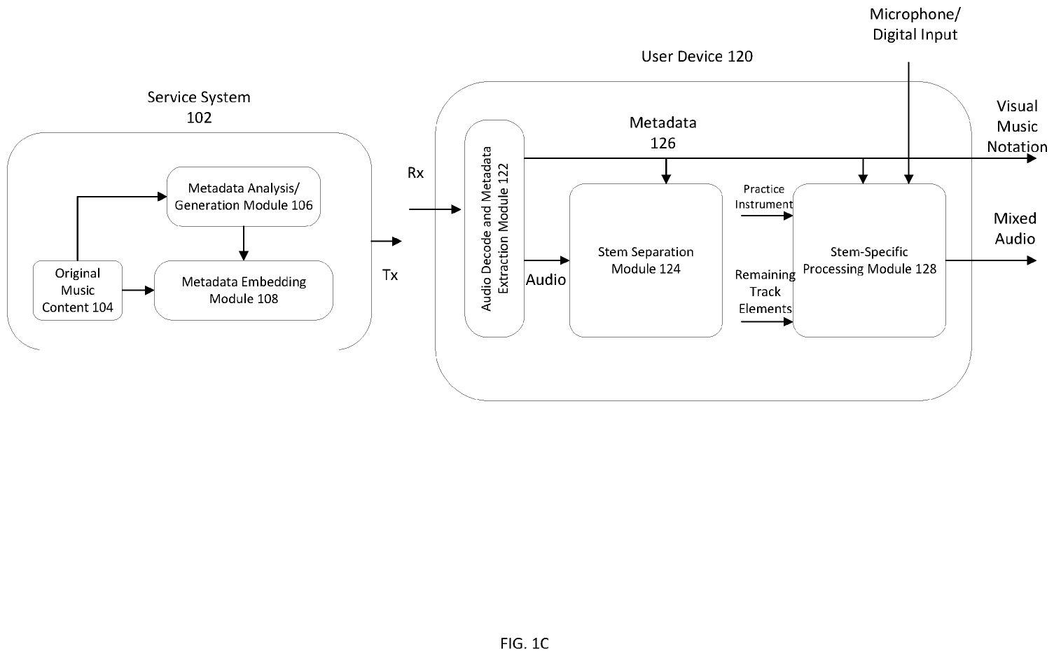

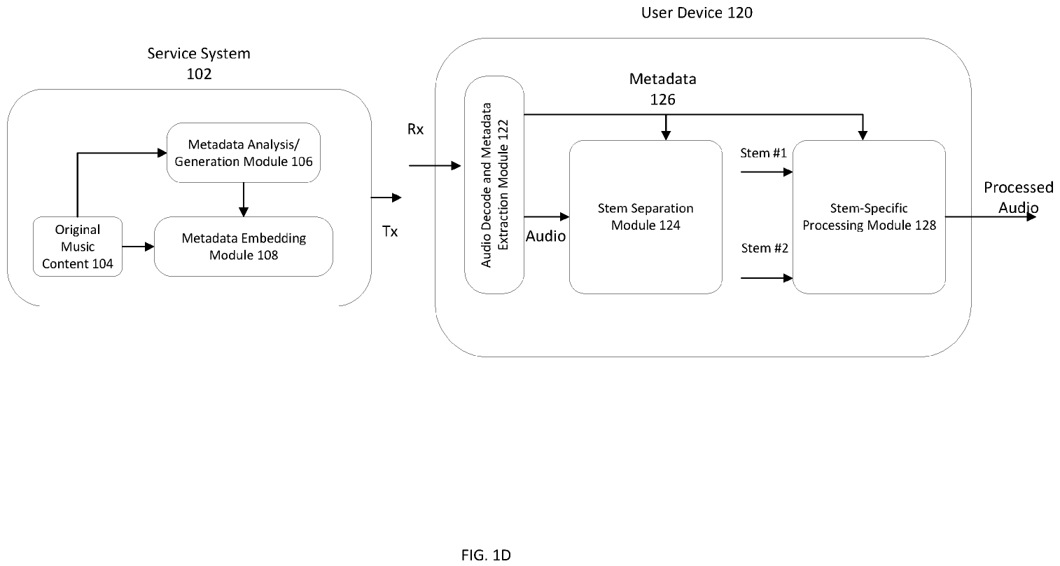

FIG. 1A illustrates a generalized ecosystem for distributing the original music content with newly created metadata. Service system 102 may be a system comprising one or more processors and memory. Service system 102 may comprise metadata analysis/generation module 106 and metadata embedding module 108. Metadata analysis/generation module 106 may receive original music content 104 and analyze each stem of the original music content 104 to generate metadata. The original music content 104 may be analyzed to generate metadata for one or more specific applications, such as solo karaoke mode, duet karaoke mode, instrumental user input mode, etc. Metadata embedding module 108 may generate metadata that includes various information relating to one or more individual stems. The generated metadata may be stored with the original music content 104.

The original music content 104 with the newly generated metadata may be transmitted to user device 120. User device 120 may comprise any type of user device that is capable of receiving the original music content 104 such as a laptop, smartphone, tablet, portable music player, etc. User device 120 may comprise an audio decode and metadata extraction module 122, stem separation module 124, and stem-specific processing module 128. User device 120 may receive the original music content 104 and the metadata at audio decode and metadata extraction module 122 (hereinafter referred to as “ADME module” 122). ADME module 122 may decode and extract metadata from the original music content 104. The extracted metadata may be sent to stem separation module 124 and stem-specific processing module 128. Stem separation module 124 may separate the original music content 104 into two or more stems (e.g., sub-mixes) based on the received metadata. The metadata may include information as to vocal stem, percussion stem, key of the songs, any special effects applied to the original vocal, etc. Stem separation module 124 may separate stems and separated stems may be sent to stem-specific processing module 128. Stem-specific processing module 128 may make use of any metadata that is defined as relevant to a specific functioning such as karaoke or instrument-only mode. If the relevant metadata is not available, stem separation module 124 and stem-specific processing module 128 may download the relevant metadata from a cloud server, where the relevant metadata for specific functioning pertaining to identical and/or similar songs may be stored or stem-specific processing module 128 may assume default values if no subsidiary metadata is available. Stem-specific processing module 128 may receive auxiliary input via a microphone or electrically connected musical instruments such as guitar, piano, or drums. Stem-specific processing module 128 may output the processed audio. User device 120 may display a text or a video stream for song lyrics or other relevant information pertaining to the original music content 104, such as music videos or musical scores on a screen of the user device such as a TV, laptop, smartphone, or tablet.

Stem-specific processing module 128 may make use of any metadata that is defined as relevant to their application-specific functioning. For example, if the original music content does not have any metadata related to vocal stems when transmitted to user device 120, stem separation module 124 may utilize a machine-learning model to identify and separate the vocal stem.

Stem separation module 124 may use the machine learning model to modify the weights and coefficients according to the user's desired output stems. The user may use device 120 to change or adjust the weights and coefficients. For example, if the user wants to separate and modify vocal stems from the original music content, the user may increase the weights of the pre-trained machine-learning model for a more accurate separation of the vocal stem.

FIG. 1B illustrates an example enhanced music delivery system deployed in a karaoke application. For the karaoke application, the original music content 104 may be sent to metadata analysis/generation module 106 and metadata embedding module 108 to generate karaoke-specific metadata. The karaoke-specific metadata may include information relating to the singer's vocal features and the characteristics of the singers, original song key, any vocal effects applied to the original singer's vocal (e.g., reverb, chorus, autotune, etc.), song lyrics, and timing relating to the musical structure of the music content. In some examples, the metadata may also include information related to the original music content's digital rights. For example, the original music content's digital rights may contain the restrictions that the publisher or the owner of the original music content may not permit the distribution of a karaoke version of the music content, or such use is permitted on a subscription basis.

For example, information as to the timing of the song chorus or the timing when certain effects are applied may be generated as metadata for the karaoke application. User device 120 may receive the above karaoke-specific metadata stored with the original music content 104 to extract the karaoke-specific metadata at ADME module 122.

Stem separation module 124 may separate the original music content 104 into separate stems. Such stems may include lead singer stem and backing singer stem. Stem separation module 124 may utilize a machine learning model to discern additional stems based on the received metadata. Stem-specific processing module 128 may receive stems such as lead vocal stem, backing vocal stem and music stem to specifically process for karaoke applications. Stem-specific processing module 128 may receive the user's microphone input, such as the user's singing voice, and modify the lead singer stem when such user audio input is received. The user audio input may be mixed with the music stems and/or backing singer stems. In duet karaoke mode, the original lead singer stem may be partially or fully attenuated only when the user audio input is detected at stem-specific processing module 128. Stem-specific processing module 128 may monitor the user's microphone signal level or it may use machine learning models to detect the user's audio input.

In some examples, the lead singer stem can be enabled even when the user audio input is detected at stem-specific processing module 128 during the song chorus. The timing of the chorus may be stored as song metadata.

In some examples, user device 120 can operate in solo karaoke mode or duet mode. In solo karaoke mode, stem-specific processing module 128 may partially or fully attenuate the original lead singer's vocals for the duration of the song and mix the user audio input with the stems for backing singers and music. In duet karaoke mode, stem-specific processing module 128 may partially or fully attenuate the original lead singer's vocals only when the user's audio input is received at a microphone unit, such that user device 120 may output the resulting track alternating between the original lead singer's vocals and the user's audio input. In other examples, when stem-specific processing module 128 detects the user audio input during the song chorus, stem-specific processing module 128 may enable the lead singer's vocals such that both the user's and the original lead singer's voices are played together.

In other examples, stem-specific processing module 128 may apply the original voice effects to the detected user audio input. In some examples, user device 120 may display synchronized song lyrics when karaoke mode is enabled. In some other examples, the song lyrics may be stored directly as metadata or indirectly stored using a unique identifier and/or a uniform resource locator (URL). Stem-specific processing module 120 may also include an echo canceller to avoid feedback from speakers to the user's microphone. In karaoke mode, user device 200 may further compare the user's singing performance to the original singing performance to display performance scores. In some other examples, stem-specific processing module 128 may utilize a machine learning model to determine challenging parts of the song such that the singer's key or range may be modified the next time the same song is performed by the user. In some examples, stem-specific processing module 128 may analyze the user's loudness level and match it to the loudness of other stems of the original music content using an automatic gain control (AGC) circuit or a loudness normalization technique.

FIG. 1C illustrates an example enhanced music delivery system for removing music stems for instrumental accompaniment and learning. Stem separation module 124 may separate stems for specific instruments or a group of instruments from the original music content 104. Service system 102 may transmit original music content 104 with music instrument-specific metadata such as parameters relating to the audio effects applied to the original instrument during production (e.g., reverb, chorus, pedal effects), original song key, music notation for each instrument, the timing relating to the musical structures such as tempo, the timing of chorus, etc. The metadata may include information relating to certain restrictions on the specific use of particular instruments. For example, the owner of original music content 104 may not permit a particular instrument stem removal for specific music. Such right may pertain to musical notation publishing rights or contain information as to what kind of processing is permitted for particular instrument stems. The metadata may be generated by metadata analysis/generation module 106. Metadata analysis/generation module 106 may utilize a machine learning model to generate the above-described metadata from original music content 104.

User device 120 may receive original music content 104 with the metadata to decode, separate and process the relevant stems. For example, stem separation module 124 may separate the stems into a vocal stem, drum stem, bass stem, and guitar stem. The separated stems may be processed by stem-specific processing module 128. Stem-specific processing module 128 may utilize audio mixers and effects processors. Stem-specific processing module may process the separated stems in instrumental mode. In the instrumental mode, stem-specific processing module 128 may partially or fully attenuate an original instrument stem for a duration of the entire original music content 104 when a user starts playing the same instrument. Stem-specific processing module 128 may receive the audio input from the user's instrument and mix the user's audio input with the remaining instrument and music stems. Stem-specific processing module 128 may apply certain effects to the user audio input if such effects were applied to the original instrument sound. The effects may be applied in real time, such that as the user audio input is received through a microphone, it is played back through a speaker with the applied audio effects or via a musical instrument digital interface (MIDI).

Stem-specific processing module 128 may process the separated stems in ducling instrumental mode. In dueling instrumental mode, an original instrument may be partially or fully attenuated only when an accompanying instrument sound played by the user is detected. Stem-specific processing module 128 may detect the accompanying instrument sound by monitoring the microphone signal level, digital waveform signal, or an input midi channel. In some other examples, the original instrument can be still played even when the user plays the same instrument for certain parts of the song where the user may wish to play a section with the original musician playing the original instrument. Stem-specific processing module 128 may process the separated stems in solo instrument mode where all stems except the instrument of interest may be partially or fully attenuated such that the user may listen to only one stem for the instrument of interest for learning purposes. Stem-specific processing module 128 may utilize a loudness normalization technique to balance the input level of the user's instrument and the loudness of the remaining music and instrument stems. Stem-specific processing module 128 may utilize an echo canceller or feedback cancellation circuit to avoid feedback from the output of the mixed audio to the microphone.

In some examples, stem-specific processing module 128 may use a midi synthesizer that may emulate instruments used in the recording of original music content 104. A specific midi sound bank may be included in original music content 104 by metadata embedding module 108. User device 120 may determine a performance score of the user's instrumental performance and display the determined score via a graphical user interface. Stem-specific processing module 128 may determine challenging parts of original music content 104 such that the user may practice with the music notation displayed by user device 120. In some examples, user device 120 may modify the music notations for particular instruments based on the user's performance level. User device 120 may also display music notations or a URL describing a location to find the music notations to the user via a graphical user interface. User device 120 may also display guitar tablature, drum notation, standard music notation, lead sheets, or other graphical music notation while the user plays the instrument.

FIG. 1D illustrates an example enhanced music delivery system for performing stem-based post-processing. In this example, the enhanced music delivery system may use stem-specific processing module 128 to apply different digital signal processing (DSP) effects to different stems. For example, stem-specific processing module 128 may enhance original music content 104's drum stem to emphasize the music's percussive beat during sports activities. Metadata analysis/generation module 106 may generate metadata including a definition of how the stems can be segmented, the effect applied to each stem, and digital embedding relating to a specific instrument or set of stems that may enhance the source separation technique to isolate a particular instrument.

Stem separation module 124 may separate all supported instrument stems from original music content 104 based on the generated metadata. If such metadata is not available, then stem separation module 104 may choose a default instrument grouping scheme to separate particular instrument stems. Each stem may be processed separately and remixed by stem-specific processing module 128 based on the user's preference. For example, if a user wishes to listen to enhanced percussive stems or listen to lead vocals with better comprehension in the presence of background noise, stem-specific processing module 128 may use and apply stem-specific equalization selectively.

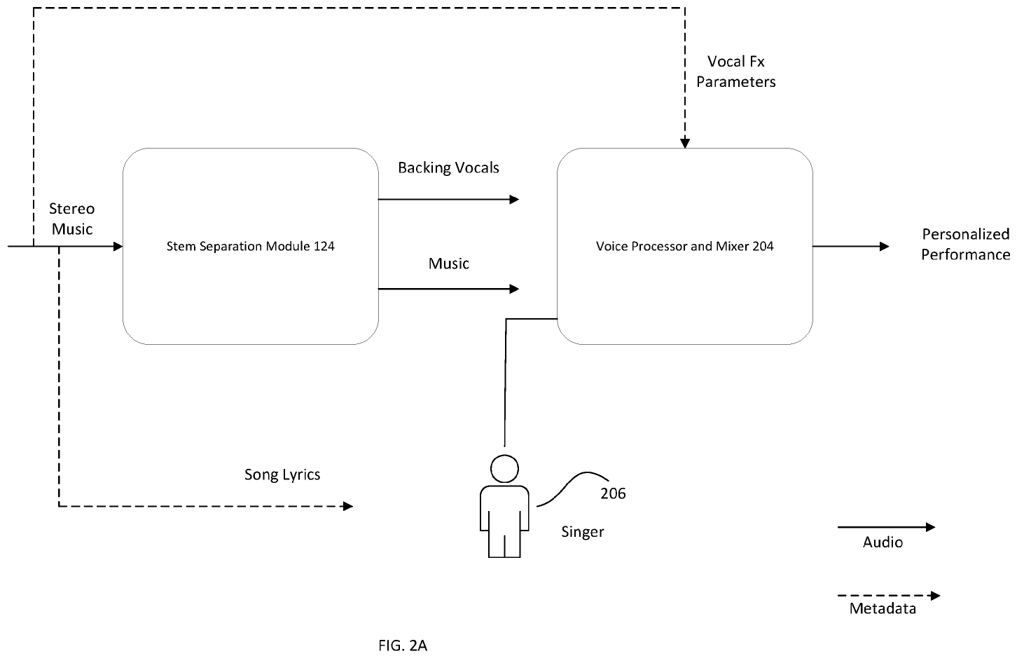

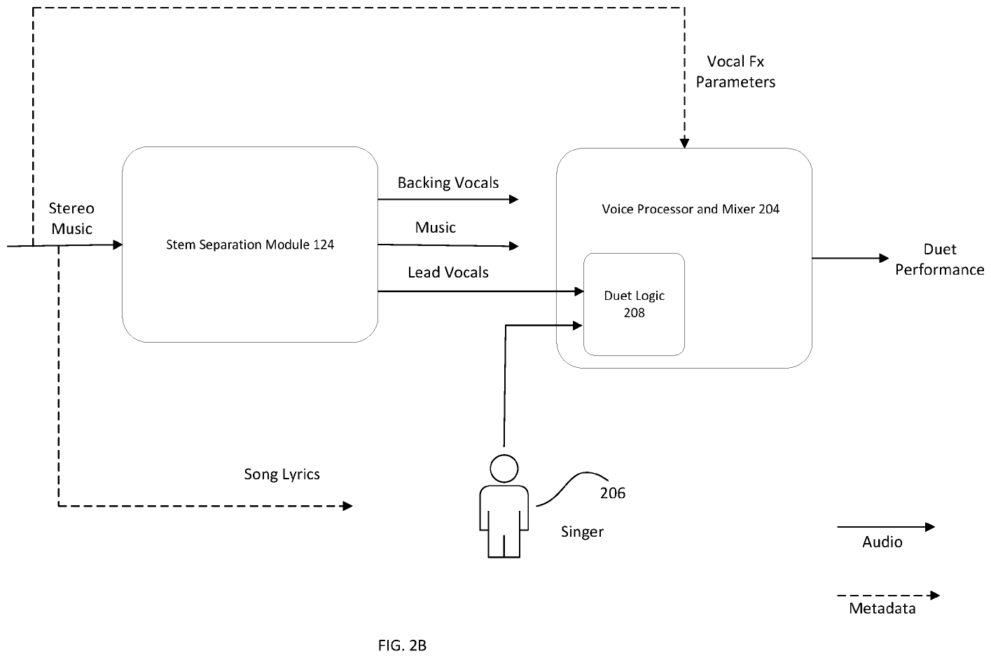

FIG. 2A illustrates an example single karaoke application. Stem separation module 124 may receive stereo music and separate the original songs into backing vocal stems and music stems. The stereo music may be transmitted with the metadata relating to the lead vocal features and the song lyrics. The song lyrics may be displayed to singer 206 while singer 206 is singing along to the stereo music via a microphone connected to voice processor and mixer 204. In some examples, voice processor and mixer 204 may be sub-component of stem-specific processing module 128 as illustrated in FIG. 1A-D. Singer 206's vocal may be processed and mixed with the backing vocal stems and the remaining music stems. Singer 206's vocal may be modified based on the original singer's vocal parameters. Singer 206's vocal is adjusted to match the features of the original singer's vocal, such that the newly mixed music may sound similar to the originally produced music.

FIG. 2B illustrates an example duet karaoke application. Stem separation module 124 may separate stereo music into a backing vocal stem, music stem and lead vocals stem. Voice processor and mixer 204 may contain duet logic 208. When singer 206 begins singing, duet logic 208 may detect singer 206's audio input and partially or fully attenuate the lead vocal stem. When singer 206 is not singing, duet logic 208 may enable the lead vocal stem to play such that it sounds like singer 206 and the singer of the original music are singing a duet song. Voice processor and mixer 204 may adjust the loudness of the backing vocal stem and music stem based on the loudness of singer 206's input audio. Voice processor and mixer 204 may mix the singer 206's vocal, original lead vocal, and other music stems to sound similar to the original music content.

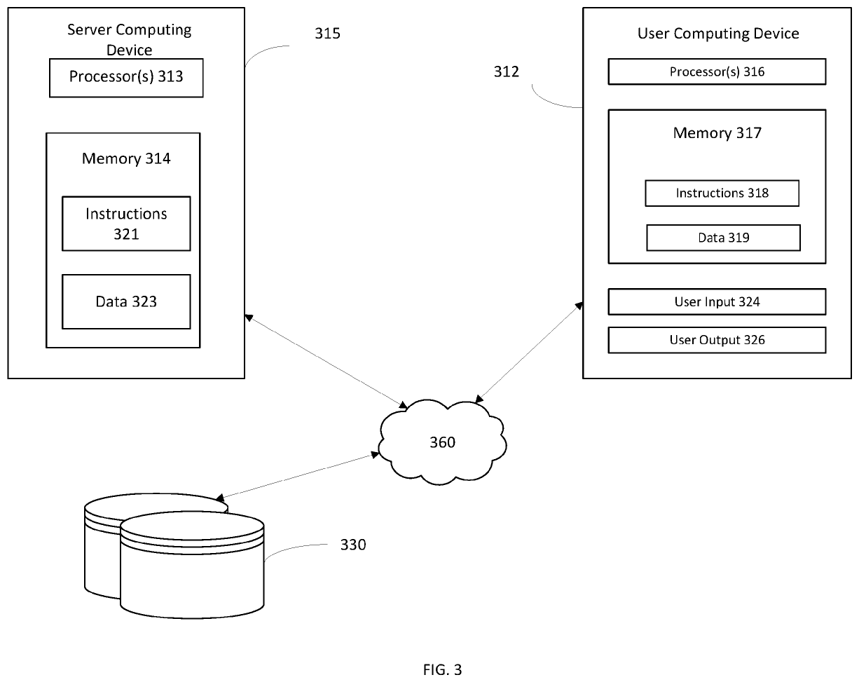

FIG. 3 depicts a block diagram of an example enhanced music delivery system. The enhanced music delivery system can be implemented on one or more devices having one or more processors in one or more locations, such as in server computing device 315. User computing device 312 and server computing device 315 can be communicatively coupled to one or more storage devices 330 over a network 360. The storage device(s) 330 can be a combination of volatile and non-volatile memory and can be at the same or different physical locations than the computing devices 312, 315. For example, the storage device(s) 330 can include any type of non-transitory computer-readable medium capable of storing information, such as a hard drive, solid-state drive, tape drive, optical storage, memory card, ROM, RAM, DVD, CD-ROM, write-capable, and read-only memories.

The server computing device 315 can include one or more processors 313 and memory 314. Memory 314 can store information accessible by the processor(s) 313, including instructions 321 that can be executed by the processor(s) 313. Memory 314 can also include data 323 that can be retrieved, manipulated, or stored by the processor(s) 313. Memory 314 can be a type of non-transitory computer-readable medium capable of storing information accessible by the processor(s) 313, such as volatile and non-volatile memory. The processor(s) 313 can include one or more central processing units (CPUs), graphic processing units (GPUs), field-programmable gate arrays (FPGAs), and/or application-specific integrated circuits (ASICs), such as tensor processing units (TPUs).

Instructions 321 can include one or more instructions that when executed by the processor(s) 313, cause one or more processors to perform actions defined by the instructions. The instructions 321 can be stored in object code format for direct processing by the processor(s) 313, or in other formats including interpretable scripts or collections of independent source code modules that are interpreted on demand or compiled in advance. Instructions 321 can include instructions for implementing processes consistent with aspects of this disclosure. Such processes can be executed using the processor(s) 313, and/or using other processors remotely located from the server computing device 315.

Data 323 can be retrieved, stored, or modified by the processor(s) 313 in accordance with instructions 321. The data 323 can be stored in computer registers, in a relational or non-relational database as a table having a plurality of different fields and records, or as JSON, YAML, proto, or XML documents. The data 323 can also be formatted in a computer-readable format such as, but not limited to, binary values, ASCII, or Unicode. Moreover, data 323 can include information sufficient to identify relevant information, such as numbers, descriptive text, proprietary codes, pointers, references to data stored in other memories, including other network locations, or information that is used by a function to calculate relevant data.

The user computing device 312 can also be configured similar to the server computing device 315, with one or more processors 316, memory 317, instructions 318, and data 319. The user computing device 312 can also include a user output 326, and a user input 324. The user input 324 can include any appropriate mechanism or technique for receiving input from a user, such as a keyboard, mouse, mechanical actuators, soft actuators, touchscreens, microphones, and sensors.

The server computing device 315 can be configured to transmit data to the user computing device 312, and the user computing device 312 can be configured to display at least a portion of the received data on a display implemented as part of the user output 326. The user output 326 can also be used for displaying an interface between the user computing device 312 and the server computing device 315. The user output 326 can alternatively or additionally include one or more speakers, transducers, or other audio outputs, a haptic interface, or other tactile feedback that provides non-visual and non-audible information to the platform user of the user computing device 312.

Although FIG. 3 illustrates the processors 313, 316 and the memories 314, 317 as being within the computing devices 315, 312, components described in this specification, including the processors 313, 316 and the memories 314, 317 can include multiple processors and memories that can operate in different physical locations and not within the same computing device. For example, some of the instructions 321, 318, and data 323, and 319 can be stored on a removable SD card and others within a read-only computer chip. Some or all of the instructions and data can be stored in a location physically remote from, yet still accessible by, the processors 313, 316. Similarly, processors 313, and 316 can include a collection of processors that can perform concurrent and/or sequential operations. Computing devices 315, and 312 can each include one or more internal clocks providing timing information, which can be used for time measurement for operations and programs run by computing devices 315, and 312.

The server computing device 315 can be configured to receive requests to process data from the user computing device 312. For example, environment 300 can be part of a computing platform configured to provide a variety of services to users, through various user interfaces and/or APIs exposing the platform services. One or more services may be online multi-user event participation. The user computing device 312 may receive and transmit data related to an online multi-user event participants' state, profile information, historical data, etc.

Devices 312 and 315 can be capable of direct and indirect communication over network 360. Devices 312 and 315 can set up listening sockets that may accept an initiating connection for sending and receiving information. The network 360 itself can include various configurations and protocols including the Internet, World Wide Web, intranets, virtual private networks, wide area networks, local networks, and private networks using communication protocols proprietary to one or more companies. Network 360 can support a variety of short-and long-range connections. The network 360, in addition, or alternatively, can also support wired connections between devices 312, and 315, including over various types of Ethernet connection.

Although a single server computing device 315 and user computing device 312 are shown in FIG. 3, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

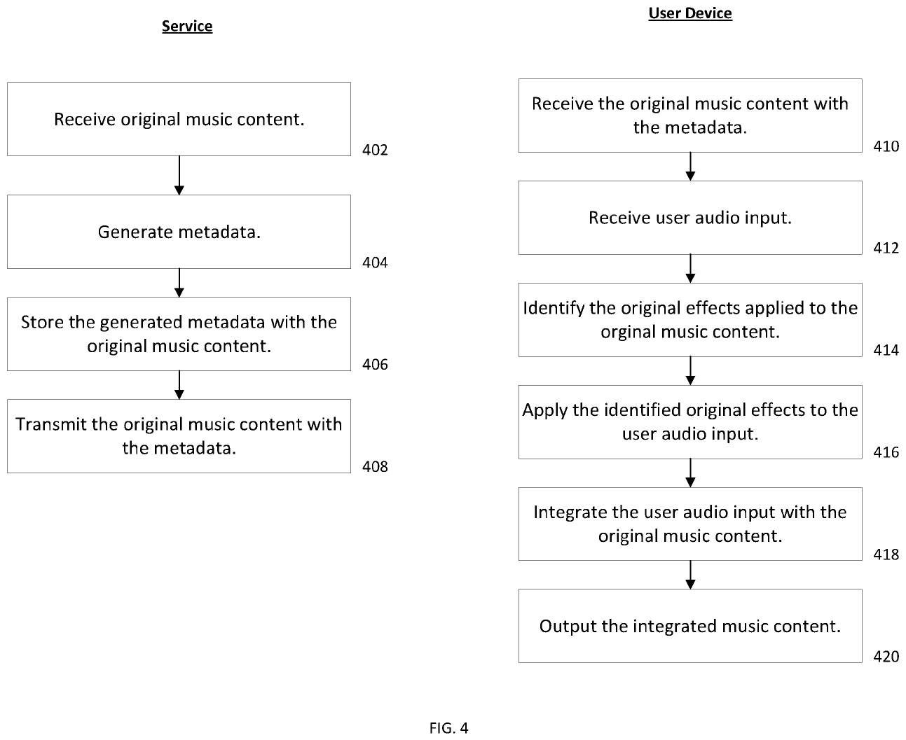

FIG. 4 depicts a flow diagram of an example method for providing an enhanced music delivery. According to block 402, original music content is received. According to block 404, the metadata relating to each stem, special effects, song lyrics, digital rights, and other types of information may be generated using a machine-learning model. In some examples, the original publisher may manually provide the metadata.

According to block 406, the generated metadata may be stored with the received original music content. The metadata may also be stored in a database for future use. According to block 408, the original music content with the metadata may be transmitted by a server or service provider to a user's device.

According to block 410, the original music content with the metadata may be received at a user device such as a portable music player, smartphone, or personal computer. According to block 412, the user device may receive the user's audio input. The user's audio input may include a singing voice or instrumental sound played by the user.

According to block 414, the effects applied to the original music content are detected. For example, if a user wants to sing along to the original music content in karaoke mode, the effects applied to the original music content may be identified. Such effects may include reverb, autotune, and echo effects applied to the vocal of the original music content. Detecting such effects may include, for example, accessing metadata accompanying the music content, wherein the metadata indicates the effects applied to the content. In other examples, detecting the effects may include analyzing some or all of the music content to determine which effects were applied. In some examples, the audio processing effects, such as music key detection, song genre classification, reverb parameters, and vocal distortion effect may be determined by the user device using supplemental machine learning models or by using traditional digital signal processing techniques even if the related metadata is not available. For example, such analysis can include music key detection, song genre classification, reverb parameters, and vocal distortion effects. This on-device metadata detection may be carried out using supplemental machine learning models or by using traditional digital signal processing techniques.

According to block 416 the received user audio input may be processed in real time to apply the audio processing effects detected in block 404. By applying the identified effects to the user's singing voice, the result will resemble the original vocal sound. In some examples, certain processing effects with default parameter may be applied if no metadata is available. The user may select to use the user's own presents stored on the user device.

According to block 418, the user audio input is integrated with the original music content. The modified user's singing voice may be integrated with the original music content. The original vocal stem may be muted or attenuated as the user continues to sing along to the original music content. In duet karaoke mode, the original vocal sound may be enabled when the user pauses or stops singing such that the user's singing voice and the original vocal sound may be interchangeably played to sound like a duet song.

According to block 420, the integrated music content is output. The integrated music is output at the user device such that other users may listen to the integrated music. The song lyrics and/or musical notation may be displayed to the user and audiences.

Some or all of the steps described above may be performed in real time or near real time. For example, as a song is streamed and user audio input is received to accompany the song, the user audio input may be processed, integrated, and output with stems of the original content in real time.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, cause the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system for enhancing music delivery service with metadata, the system comprising:
one or more processors; and
memory in communication with the one or more processors, wherein the memory contains instructions configured to cause the one or more processors to:
receive original music content;
detect effects applied to the original music content;
receive user audio input;
modify, in real time, the user audio input by applying effects based on the detected effects applied to the original music content; and
integrate the modified user audio input with the original music content.

2. The system of claim 1, wherein the user audio input comprises a vocal sound of the user.

3. The system of claim 1, wherein the user audio input comprises an instrumental sound made from an instrument played by the user.

4. The system of claim 1, wherein detecting the effects applied to the original music content comprises accessing metadata associated with the original music content.

5. The system of claim 4, wherein the metadata includes a song key, song lyrics, timing relating to a musical structure, and an artist's vocal features.

6. The system of claim 4, wherein the metadata includes information related to digital rights of the original music content, wherein the digital rights of the original music content include information relating to what post-processing can be applied to a piece of the original music content and by whom.

7. The system of claim 1, wherein the effect comprises autotune, reverb, and chorus.

8. The system of claim 7, wherein the instructions further cause the one or more processors to generate metadata based on the detected effects and to store the generated metadata with the original music content.

9. The system of claim 4, wherein the instructions further cause the one or more processors to separate subsets of sound mixes contained in the original music content.

10. The system of claim 9, wherein the instructions further cause the one or more processors to separate the subsets of the sound mixes using a machine learning model.

11. The system of claim 1, wherein the instructions further cause the one or more processors to integrate the user audio input with a vocal sound of the original music contents by replacing the vocal sounds of the original music contents with the user audio input when the user audio input is received for a musical frame and by playing the vocal sound of the original music contents when the user audio input is not received for the musical frame.

12. A method for enhancing music delivery service with metadata, the method comprising:
receiving, by one or more processors, original music content;
detecting, by the one or more processors, effects applied to the original music content;
receiving, by the one or more processors, user audio input;
modifying, by the one or more processors, in real time, the user audio input by applying effects based on the detected effects applied to the original music content; and
integrating, by the one or more processors, the modified user audio input with the original music content.

13. The method of claim 12, wherein the user audio input comprises a vocal sound of the user.

14. The method of claim 12, wherein the user audio input comprises an instrumental sound made from an instrument played by the user.

15. The method of claim 12, wherein detecting the effects applied to the original music content comprises accessing metadata associated with the original music content.

16. The method of claim 15, wherein the metadata includes a song key, song lyrics, timing relating to a musical structure, and an artist's vocal features.

17. The method of claim 15, wherein the metadata includes information related to digital rights of the original music content.

18. The method of claim 15, wherein the effect comprises autotune, reverb, and chorus.

19. The method of claim 18, the method further comprises:
generating metadata based on the detected effects and storing the generated metadata with the original music content.

20. A non-transitory machine-readable medium comprising machine-readable instructions encoded thereon for performing a method of enhancing music delivery service with metadata, the method comprising:
receiving original music content;
detecting effects applied to the original music content;
receiving user audio input;
modifying, in real time, the user audio input by applying effects based on the detected effects applied to the original music content; and
integrating the modified user audio input with the original music content.
